(19) United States
(12) Patent Application Publication
(10) Pub. No.: US 2007/0030956 A1
(43) Pub. Date: Feb. 8, 2007

(54) X-ray generator for an x-ray apparatus with x-ray lens module

(76) Inventor: Mathias Hornig, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/472,686

(22) Filed: Jun. 22, 2006

(30) Foreign Application Priority Data
Jun. 22, 2005 (DE) 10 2005 028 904.5

(51) Int. Cl. H05G 2/00

(52) U.S. Cl. 378/119

(57) ABSTRACT

In an x-ray generator for an x-ray apparatus with an x-ray tube (10) from which x-rays exit at a beam exit window, an x-ray lens module is provided that is located in the immediate proximity of and in front of the beam exit window. The x-ray lens module allows the insertion (switching) of an x-ray lens into the beam path of the x-rays.

### BACKGROUND OF THE INVENTION

1. Field of the Invention

The present invention concerns an x-ray radiator for an x-ray apparatus that, as is typical, has an x-ray tube from which x-rays exit at an exit window.

2. Description of the Prior Art

In angiographic applications and in particular in the field of neurology, it is meaningful to show partial regions of x-ray images in high resolution, for example in order to make detailed structures of and at vessels or stents visible.

High-resolution x-ray detectors are known. For detectors with pixel sizes of 20 μm up to 80 μm, a high x-ray dose is required so that suitable signals per pixel can be generated. These high power requirements can be satisfied only conditionally or not at all by x-ray tubes with conventional x-ray generators.

### SUMMARY OF THE INVENTION

An object of the present invention is to provide an x-ray apparatus such that the performance of the tube for predetermined applications and detectors can be increased in a flexible manner and without a substantial conversion being necessary existing x-ray generators.

This object is achieved in accordance with the present invention by an x-ray generator having an x-ray lens module in immediate proximity to or at the beam exit window, the x-ray lens module enabling the insertion of an x-ray lens into the beam path of the x-rays.

By providing an x-ray lens module at the x-ray tube, the exiting x-rays can be focused and the power can thereby be locally increased. Rebuilding of the x-ray tube is no longer necessary to provide it with a separate x-ray lens module. The x-ray lens module is provided in the immediate proximity of or on the exit window such that the x-ray which exits can be focused in a sufficient manner. The addition of the x-ray lens into the beam path of the x-ray can ensue dependent on the application and can be adapted to the respective detector format.

In a preferred embodiment, at least one lens in the x-ray lens module can be tilted. A lens can also be pivotable. Moreover, a number of x-ray lenses can be provided, such as lenses with different foci relative to one another, which can be selectively pivoted into the beam path.

The individual lenses preferably are mechanically movable relative to the beam exit window, for example in the beam direction (to change the focus) and/or perpendicular thereto. In a preferred embodiment, the entire x-ray lens module is movable.

The x-ray generator also can have a diaphragm device in a typical manner. The x-ray lens module is preferably provided between the x-ray tube (thus between the exit window of the x-ray tube) and the diaphragm device. In a preferred embodiment, the x-ray lens module is at least partially integrated into the diaphragm device in the beam path so that space is saved. The reason for this is that previously typical lenses can absolutely occupy a relatively large amount of space.

The x-ray lenses are conventional lenses as currently exist and are tested in research, for example in material examination, but the use of such x-ray lenses in medical technology has not previously occurred.

### DESCRIPTION OF THE DRAWINGS

FIG. 1a shows the inventive x-ray generator according to a first embodiment, with an x-ray tube is additionally shown in perspective.

FIG. 1b shows the x-ray generator of FIG. 1a in a plan view, with an x-ray lens module attached.

FIG. 2 shows the inventive x-ray generator according to a second embodiment, with a plan view of the x-ray lens module attached.

FIG. 3 shows the inventive x-ray generator according to a third embodiment.

FIG. 4 shows the inventive x-ray generator according to a fourth embodiment.

### DESCRIPTION OF THE PREFERRED EMBODIMENTS

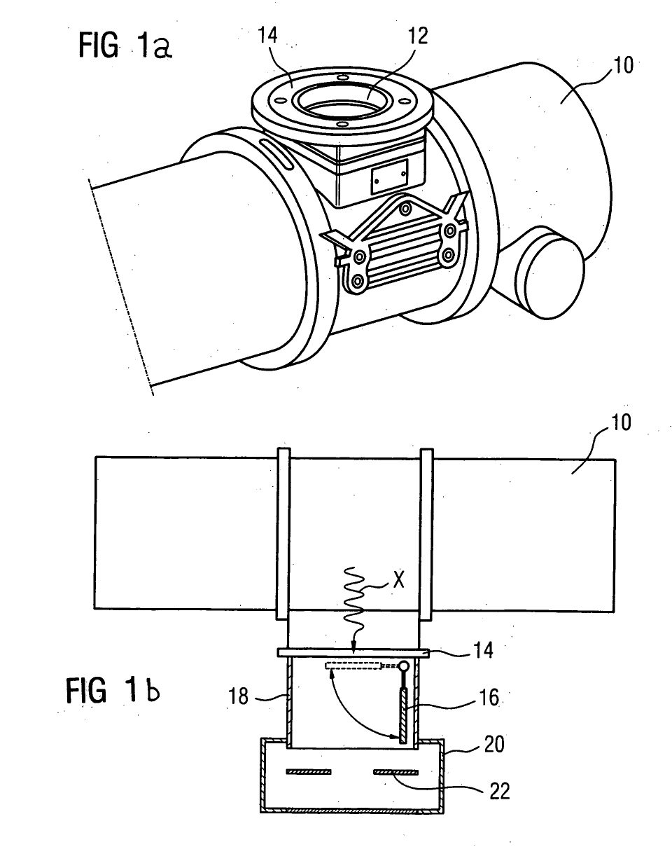

An inventive x-ray generator as it is shown in FIG 1a having an x-ray tube 10 shown in perspective in the upper part of FIG 1a. This is a conventional x-ray tube 10, thus an x-ray tube that internally contains a cathode that emits electrons that strike an anode, at which x-rays are generated. The x-rays exit through an exit window 12 (shown particularly well in the perspective view). A radiator flange 14 on which further units can be attached is located at the exit window. As can be seen in FIG. 1b, an x-ray lens module 16 that has a pivotable (hinged) x-ray lens 18 is mounted on the radiator flange 14. The x-ray lens 18 can be located in a rest position (shown with solid line) and can be pivoted out of the rest position into the position shown dashed in front of the window 12. Given a pivoted lens 18, the x-ray radiation (here schematically indicated and designated with X) that exits from the window 12 therefore passes through the x-ray lens and is focused. The x-ray radiation subsequently passes through a diaphragm device 20 with a diaphragm 22.

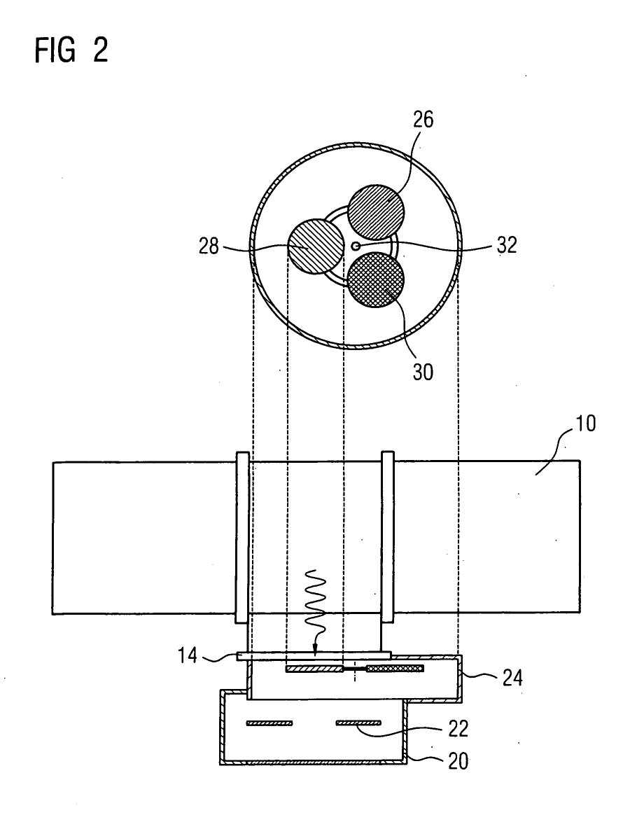

Arranging the lens 18 so as to be tiltable in the embodiment shown in FIG. 1b causes the overall installation height of the x-ray lens module 16 to be increased, Alternatively, therefore, the x-ray lens can be pivotable. This is shown in FIG. 2. An x-ray tube 10 is again shown with a flange 14, the diaphragm device 20 with the diaphragm 22 as well as with x-ray module 24 adapted between them. Here the x-ray module has three lenses 26, 28 and 30 that are rotatable in a circle around a center point 32 according to the revolver principle, as in an optical microscope. The lenses 26, 28 and 30 have different foci, such that the respectively needed lens can be selected from the three lenses 26, 28 and 30 specific to the application.

In FIG. 2 the x-ray lens module 24 is inserted directly between the flange 14 and the diaphragm device 20.

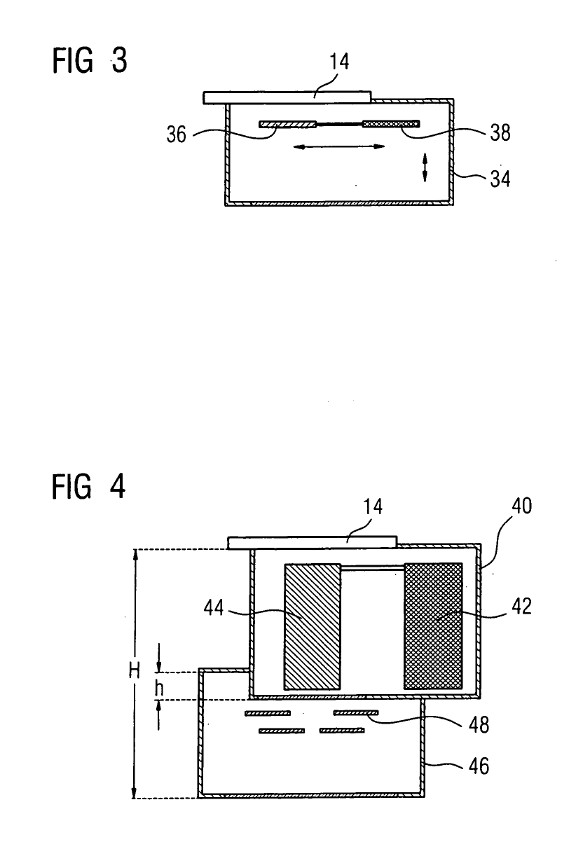

If more space is available, it is possible to make the x-ray lenses movable multi-dimensionally. This is schematically indicated in FIG. 3: in the x-ray lens module 34, two lenses 36 and 38 are movable both in the horizontal direction and in the height direction (see the corresponding arrows). A small electromotor can be used to move the lenses. Different parts of the x-ray beam can be bundled differently by the movement in the horizontal direction. The adjustment of the focus can be adapted via a movement in the height direction.

It is necessary that the individual lenses 36 and 38 be moved within the x-ray module 34. The entire x-ray module alternatively can be movable. In such an x-ray module, the x-ray module is mounted on a slot attached to the flange 14 and be moved as a whole.

A frequent problem already mentioned above is lack of space for the x-ray lens module.

FIG. 4 shows a further embodiment of the invention. In this embodiment, an x-ray module 40 that contains particularly large lenses 42 and 44 is located on the flange 14. The x-ray module is here integrated into a subsequent diaphragm device 46, i.e. it penetrates into a casing of the diaphragm device 46 up to the proximity of a diaphragm 48. Because the x-ray module 40 penetrates into the diaphragm device 46, height h is saved, meaning that the total height H is equal to the height of the x-ray lens module 40 and the diaphragm device 46 less the height h that is mutually occupied. In all embodiments, the individual lenses can be switched (i.e. added) into the beam path of the x-ray that exits from the window 12 (see FIG. 1b). However, the x-ray tube 10 is in principle also operable without switching of the lenses. It is possible to increase the power of the x-ray tube 10 locally in an application-dependent manner using the lenses; but the x-ray apparatus is otherwise operated in the manner a conventional x-ray apparatus.

Although modifications and changes may be suggested by those skilled in the art, it is the intention of the inventor to embody within the patent warranted hereon all changes and modifications as reasonably and properly come within the scope of his contribution to the art.

I claim as my invention:

1. An x-ray generator for an x-ray apparatus, comprising:
an x-ray tube that emits x-rays;
a radiator housing, containing said x-ray tube, with a beam exit window through which said x-rays exit in a beam path; and
an x-ray lens module disposed immediately proximate said beam exit window, said x-ray lens module containing at least one x-ray lens and a mounting arrangement for said at least one x-ray lens allowing selective insertion of said at least one x-ray lens into said beam path of said x-rays.

2. An x-ray generator as claimed in claim 1 wherein said mounting arrangement is a pivot arrangement allowing said at least one x-ray lens to be pivoted into and out of said beam path of said x-rays.

3. An x-ray generator as claimed in claim 1 wherein said mounting arrangement is a rotatable arrangement allowing said at least one x-ray lens to be rotated into and out of said beam path of said x-rays.

4. An x-ray generator as claimed in claim 3 wherein said x-ray lens module comprises a plurality of x-ray lenses mounted on said rotatable arrangement, said rotatable arrangement being rotatable to insert any of said plurality of x-ray lenses, one at a time, into said beam path of said x-rays.

5. An x-ray generator as clairned in claim 4 wherein said plurality of x-ray lenses have respectively different foci.

6. An x-ray generator as claimed in claim 1 wherein said mounting arrangement allows multi-dimensional movement of said at least one x-ray lens with respect to said beam path of said x-rays.

7. An x-ray generator as claimed in claim 1 wherein said x-ray lens module, with said x-ray lens therein, is mechanically movable in at least one direction relative to said beam path of said x-rays.

8. An x-ray generator as claimed in claim 1 wherein said x-ray lens module is directly attached on said radiator housing.

9. An x-ray generator as claimed in claim 1 comprising a radiation diaphragm device disposed in said beam path of said x-rays, and wherein said x-ray lens module is at least partially integrated into said diaphragm device.
